(19) United States
(12) Patent Application Publication
(10) Pub. No.: US 2008/0083786 A1
(43) Pub. Date: Apr. 10, 2008

(54) FLUID SOAP DISPENSER AND FLUID SOAP BOTTLE ASSOCIATED TO THE DISPENSER

(75) Inventor: Manuel Suarez Marin, Barcelona (ES)

Correspondence Address: COLLEN IP, THE HOLYOKE MANHATTAN BUILDING, 80 SOUTH HIGHLAND AVENUE, OSSINING, NY, 10562, US

(73) Assignee: PROANDRE, S.L., GRANOLLERS (BARCELONA) (ES)

(21) Appl. No.: 11/858,397

(22) Filed: Sep. 20, 2007

(30) Foreign Application Priority Data
Oct. 6, 2006 (ES) P200602539
Oct. 6, 2006 (ES) P200602540

(51) Int. Cl. B67D 5/06

(52) U.S. Cl. 222/181.3

(57) ABSTRACT

Fluid soap dispenser. Comprises a rear body (2) with wall mounting means and means for the removable support and coupling of a container bottle (10) for soap; a pivoting front cover (3), articulated pivotally to the rear body (2), and means for dispensing the soap, actuated when the cover (3) is pushed against the container bottle (10) and the latter against the rear body (2) by pressing the cover against the rear body. The means for the removable support and coupling of the soap container bottle comprise a projection (9) of the inner wall of the rear body (2), adapted to collaborate with a complementary opening (30) with which the soap container bottle (10) is provided.

### TECHNICAL FIELD OF THE INVENTION

The invention relates to a device for dispensing fluid, liquid, or semi-liquid soap, of the type comprising:
a rear body with wall mounting means and means for the removable support and coupling of a deformable soap container bottle,
a front pivoting cover, articulated pivotally to the rear body, and
means for dispensing the soap, actuated when the front cover is pressed against the container bottle and against a projection of the rear body, as the front cover is made to pivot over the rear body.

### BACKGROUND OF THE INVENTION

German patent DE2306297n discloses a device for dispensing a pasty product such as soap, according to the preamble of claim 1.

These dispensers are commonly used in sanitary and domestic applications and are designed for mounting on a wall.

Patents U.S. Pat. No. 5,248,066, U.S. Pat. No. 5,265,772, U.S. Pat. No. 5,443,236, U.S. Pat. No. 5,465,877, U.S. Pat. No. 5,625,659, U.S. Pat. No. 5,944,227, EP1114606 and WO 01/28397A1 disclose different ways of embodying the generic dispenser disclosed in said German patent, all having correct functionality, but sharing the common problem of not allowing more than a single type of product to be dosed, whether it is soap, gel, hand cream, etc.

The object of the present invention is to provide a new way of embodying this dispenser, which makes it easier to use and offers improved functionality in relation to the prior art.

### EXPLANATION OF THE INVENTION

Thus, the object of the present invention is a fluid soap dispensing device, of the type indicated at the beginning, with a new concept and functionality, essentially characterised in that it also comprises means for supporting and housing a tablet of air freshener through sublimation.

According to another characteristic of the present invention, these means for supporting and housing an air-freshener tablet are offered by a supporting surface provided on top of the soap container bottle.

According to another characteristic of the present invention, the device comprises an upper lid for the air-freshener tablet, designed for mounting on top of the pivoting front cover.

The device of the present invention makes it possible to combine in a single device or apparatus the function of dispensing soap and the function of dispensing the air-freshener or deodorant product, with the ensuing advantages of saving space and money.

A special and novel way of making the hinge is contemplated, whereby the upper lid for the tablet comprises hinge means in relation to the rear body, and means for fixing to the pivoting front cover, through which the pivoting front cover is articulated pivotally to the rear body.

Preferably, the hinge is of the pin and barrel type, with the pin consisting of a cylindrical formation defined at the rear end of the upper lid, and with the barrel defined in the back and upper part of the rear body.

This makes it possible to offer a simpler, more solid and reliable articulation for the operative swinging movement of the above pivoting front cover over the rear body and against the container bottle placed between the two.

Preferably, the support surface will be essentially horizontal and solidly joined to the rear body of the dispenser.

Preferably, it will have means for fixing and holding an air-freshener tablet, consisting of panels on said surface.

According to a preferred embodiment of the means for the removable support and coupling of a soap container bottle, such means comprise a projection from the inner wall of the rear body, adapted to collaborate with a complementary opening made in the soap container bottle.

Preferably, the opening in the container bottle is a through-hole.

### BRIEF DESCRIPTION OF THE DRAWINGS

Below, is a description of a preferred albeit not exclusive embodiment of the soap dispensing device according to the present invention, wherein for improved understanding it is accompanied by drawings, provided by way of a non-limitative example. In said drawings:

FIG. 1 is a front perspective view of an example of an embodiment of the dispenser according to the invention;

FIG. 2 is a rear perspective view of the dispenser of FIG. 1;

FIG. 3 is another perspective view of the dispenser of FIG. 1, seen from below;

FIG. 4 is a bottom perspective view of a lid for the air-freshener tablet according to the invention;

FIG. 5 is an exploded view of the dispensing device of FIG. 1;

FIG. 6 is a perspective that illustrates the air-freshener of FIG. 1 with a coupled disposable soap container, and with the covers lifted, in the refill position;

FIG. 7 is a similar perspective view to FIG. 6, but with the container or refill in the position of removal, in order to illustrate the way of operating of the means for the support and coupling of the container bottle;

FIG. 8 is an elevated side view of the dispenser at rest;

FIG. 9 is a similar view to FIG. 8, but in the dispensing position by exerting pressure in the direction indicated by arrow F; and

FIGS. 10, 11 and 12 are perspectives that show various potential arrangements for mounting the dispensers according to the invention.

### DETAILED DESCRIPTION OF THE DRAWINGS

From the drawings it can be appreciated that the fluid soap dispensing device 1 of the invention consists of three bodies, namely: a rear body 2, a pivoting front cover 3 and an upper lid 4, inherent to the present invention.

A soap container 10, or refill bottle, with deformable walls, is fitted in a removable manner in the dispenser 1 in order to dispense doses of soap through a lower valve 20 of the container bottle 10, when the dispensing device 1 is actuated in the manner contemplated to this effect.

Hereafter, to refer to the air-freshener device 1 according to the invention this same expression is used or the term air-freshener, always indicated with numerical reference 1.

The rear body 2 has wall mounting means and means for the removable support and coupling of a refill container bottle 10.

The wall mounting means include adhesive strips 14 (FIG. 2) for adhesion to a smooth surface. In addition, the rear body 2 and, consequently, the dispenser 1, can be mounted to a wall using fixing plates 13, that are fixed to the wall and that can receive the adjacent mounting of more than one dispenser 1 (see FIGS. 10, 11 and 12), mounted by means of threading 15 and separated by bumpers 16 with the help of separating plates 12 that collaborate with bumpers 17 on the back side of the rear body 2.

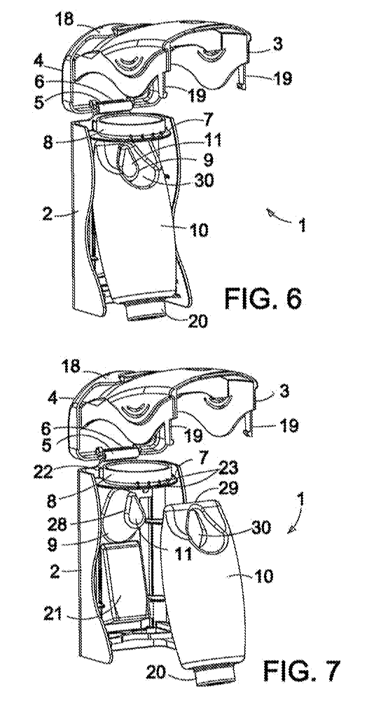

The means for the removable support and coupling consist of a projection 9 of the inner wall of the rear body 2, adapted to collaborate with a complementary opening 30 in the soap container bottle 10. The opening 30 in the container bottle 10 is preferably a through-hole, as shown in FIGS. 6 and 7. The projection 9 is preferably a protuberance of a hollow ring of tapered or cylindrical type, defining an opening or cavity 11.

Said front cover 3 is pivoting, for which it is articulated pivotally to the rear body 2, through the upper lid 4, as explained later.

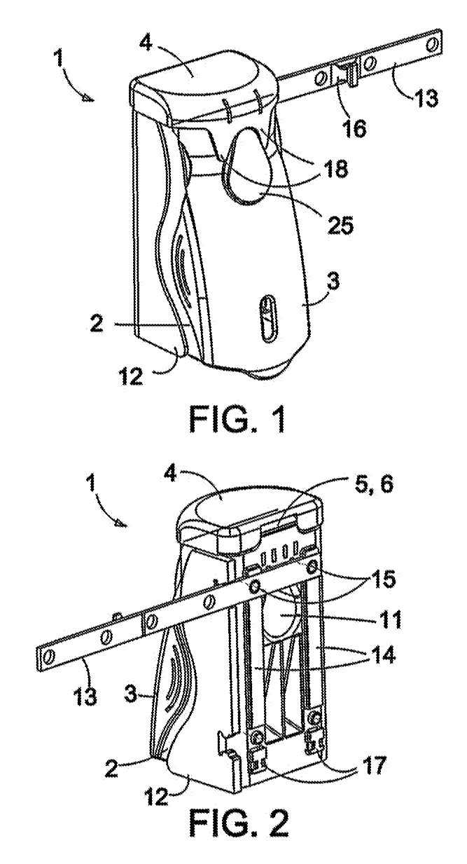

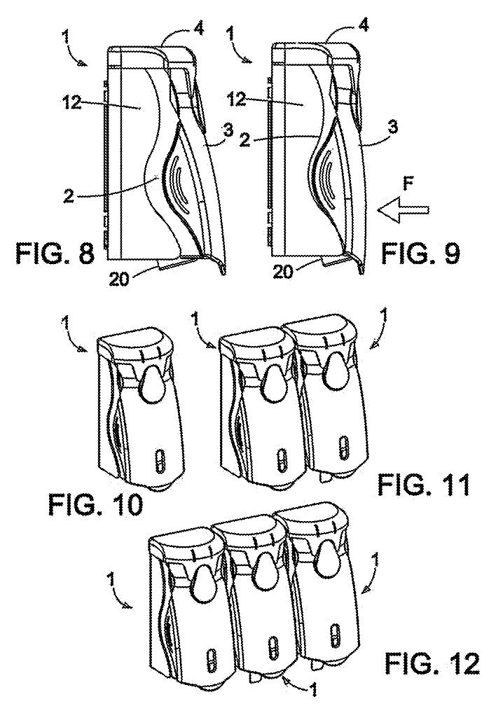

Therefore, thanks to this arrangement of elements, in the operational mounted position (FIGS. 1, 2, 3, 6, and 8 to 12), the refill container bottle 10 is introduced, when the projection 9 is made to pass through the opening 30, and is closed in between the rear body 2 and the front cover 3. As the latter is pressed against the container bottle 10, following the arrow F of FIG. 9, as the front cover 3 pivots over the rear body 2 (FIG. 9), the container 10 is pushed against a projection 21 of the rear body 2, deforming its walls, to cause the soap to flow out of the valve 20 of the container 10. The projection 21 is sufficiently wide to ensure that contact between the projection 21 and the container bottle 10 occurs over a sufficient contact surface to cause the soap to flow out, without damaging the container 10 by applying excessive pressure.

FIGS. 5, 6 and 7 show how the dispenser 1 according to the invention has means for supporting and housing a tablet 8 of air-freshener by sublimation, provided by a support surface 7, which in the operative position is horizontal and above the soap container bottle 10. Preferably, the support surface 7 is solidly joined to the rear body 2, although the possibility is contemplated that it may be solidly joined to the cover 3 or lid 4, or removable from any of parts 2, 3 and 4.

The upper lid 4 is provided to cover air-freshener tablet 8, and is mounted on the front cover 3, as indicated above, by hinge articulation means 5, 6 in relation to the rear body 2, and fixing means 18, 24, 25, 26 to the pivoting front cover 3, whereby the pivoting front cover 3 is articulated pivotally to the rear body 2. Front cover 3 is mounted removably to the upper lid 4 and the latter is coupled pivotally to the rear body 2 which houses and holds soap container 10, thanks to which it is possible to swing the front cover 3 in relation to the rear body 2.

By analysing the set of FIGS. 4 to 7, it is possible to see clearly that the hinge is of the pin and barrel type, with the pin 6 consisting of a cylindrical formation defined in the rear end of the upper lid 4 (FIG. 4), and with the barrel 5 defined in the back upper part of the rear body 2, as can be seen from FIG. 5. FIGS. 6 and 7 show how the hinge is mounted by introducing the pin 6 in the barrel 5.

Fixing means 18, 24, 25, 26 to the pivoting front cover 3 comprise projections 18 of the upper lid 4 that couple to a protuberance 25 of the front cover 3, whose inner cavity collaborates in holding and fixing the position of the outer edge 28 of the projection 9. An elastic clicking device 24, 26 produces a reversible coupling of both covers 3, 4 in an area above said projections.

From FIG. 6 it is possible to appreciate that once the refill container bottle 10 is coupled to the support projection 9, between the lower face of the upper lid 4 and the upper edge 29 of the container 10 a certain effect of adjustment through tightening is produced that collaborates efficiently in retaining the container in the body 2.

Fixing and retaining the position of container bottle 10 in the dispensing device 1 therefore occurs by means of the triple action of:
insertion of the projection 9 through the opening or through-hole 30;
fitting of the outer edge 28 in the concavity of the protuberance 25; and
adjustment with tightening of the edge 29 of the container bottle 10 against the lower face of the surface 7.

It can be appreciated from FIGS. 5, 6 and 7 that the surface 7 comprises means for fixing and retaining an air-freshener tablet 8, consisting of panels 22, 23 that in assembly hold the outer face of the tablet 8.

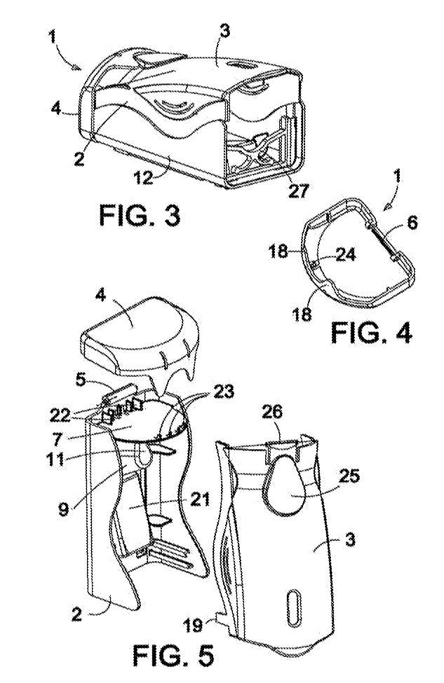

Likewise, it is possible to appreciate from said Figs. that the front cover 3 has, near its base, retaining hooks in the shape of a harpoon, which fix the closed operative position of the dispenser 1. This position can be disabled by freeing the hooks 19 by acting on a spring 27, visible in FIG. 3 of the drawings.

Having sufficiently described the nature of the present invention, as well as a way of putting it into practice, it is declared that on condition that they do not alter, change or modify its fundamental principle, all elements are subject to variations in detail.

1. Fluid soap dispensing device, of the type comprising
a rear body (2) with wall mounting means (13-17) and means for the removable support and coupling (9, 11, 30) of a deformable soap container bottle (10),
a pivoting front cover (3), articulated pivotally to the rear body (2), and
means for dispensing soap, actuated when the front cover (3) is pressed against the container bottle (10) and against a projection (21) of the rear body (2), by making the front cover swing over the rear body, characterised in that the dispensing device (1) comprises also
means for supporting and housing (7, 22, 23) a tablet (8) of air-freshener by sublimation.

2. Fluid soap dispensing device (1), according to claim 1, characterised in that said means for supporting and housing a tablet (8) of air-freshener are offered by a support surface (7) provided above the soap container bottle (10).

3. Fluid soap dispensing device (1), according to claim 1, characterised in that it comprises an upper lid (4) for the air-freshener tablet (8), designed for mounting on the pivoting front cover (3).

4. Fluid soap dispensing device, according to claim 3, characterised in that said upper lid (4) for the tablet (8) comprises hinge means (5, 6) in relation to the rear body (2), and fixing means (18, 24, 25, 26) to the pivoting front cover (3), through which the pivoting front cover (3) is articulated pivotally to the rear body.

5. Fluid soap dispensing device, according to claim 4, characterised in that the hinge is of the pin and barrel type, with the pin (6) consisting of a cylindrical formation defined in the rear end of the upper lid (4), and the barrel (5) defined in the back upper part of the rear body (2).

6. Fluid soap dispensing device (1), according to claim 2, characterised in that said support surface (7) is essentially horizontal and is solidly joined to the rear body (2) of the dispenser (1).

7. Fluid soap dispensing device (1), according to claim 6, characterised in that it comprises means for fixing and retaining an air-freshener tablet (8), consisting of panels (22, 23) on said surface.

8. Fluid soap dispensing device (1), according to claim 1, characterised in that said removable support and coupling means (9, 11, 30) for a soap container bottle (10) comprise a projection (9) of the inner wall of the rear body, adapted to collaborate with a complementary opening (30) with which the soap bottle container is provided.

9. Fluid soap dispensing device (1), according to claim 8, characterised in that said opening (30) in the container bottle (10) is a through-hole.

10. Refill soap container bottle (10) for a soap dispenser according to claim 9, characterised in that it comprises an opening (30) adapted to collaborate with a projection (9) with which the rear body (2) of the dispenser (1) is provided.

11. Container bottle (10) according to claim 10, characterised in that said opening (30) is a through-hole.
